(19) United States
(12) Patent Application Publication
(10) Pub. No.: US 2010/0294960 A1
(43) Pub. Date: Nov. 25, 2010

(54) MODULAR RADIATION SHIELD

(75) Inventor: David L. FRANK, Boca Raton, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Coconut Creek, FL (US)

(21) Appl. No.: 12/468,435

(22) Filed: May 19, 2009

(51) Int. Cl. G21F 3/04

(52) U.S. Cl. 250/517.1; 250/518.1

(57) ABSTRACT

A radiation shielding system includes at a first shielding member and at least a second shielding member that is coupled to the first shielding member. Each of the first and second shielding member includes a moderator material. At least the first shielding member includes at least one locking member extending from a surface of a region where the at least one locking member is disposed. At least the second shielding member includes at least one recessed area on a side of the second shielding member corresponding to the side of the first shielding member. The second shielding member is coupled to the first shielding member by the recessed area receiving the locking member.

### CROSS REFERENCE TO RELATED APPLICATIONS

This application is based on, and claims priority from, prior co-pending U.S. Provisional Patent Application No. 60/128,091, filed on May 19, 2008, by inventor David L. FRANK, and entitled “MODULAR RADIATION SHIELD” the entire disclosure of which is hereby incorporated by reference.

### FIELD OF THE INVENTION

The present invention generally relates to the field of radiation shielding, and more particularly relates to modular radiation shielding systems.

### BACKGROUND OF THE INVENTION

Current shielding structures used for radiation/nuclear applications or general radiation and nuclear protection are generally constructed structures that are large and extremely heavy. These conventional shielding structures are difficult to transport and are typically permanent structures that require substantial installation time and costs.

### SUMMARY OF THE INVENTION

In one embodiment, a radiation shielding system is disclosed. The radiation shielding system comprises at a first shielding member and at least a second shielding member that is coupled to the first shielding member. Each of the first and second shielding member comprises a moderator material. At least the first shielding member comprises at least one locking member extending from a surface of a region where the at least one locking member is disposed. At least the second shielding member comprises at least one recessed area on a side of the second shielding member corresponding to the side of the first shielding member. The second shielding member is coupled to the first shielding member by the recessed area receiving the locking member.

In another embodiment an interlocking radiation shield member is disclosed. The interlocking radiation shield member includes a moderator material. The radiation shield member also includes at least of one or more locking members extending from a surface of a region where the one or more locking members are disposed and at least one recessed adapted to receive a locking member of an interlocking radiation shield member.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 illustrates a top-side view of an interlocking moderator member for creating a radiation shielding structure according to one embodiment of the present invention;

FIG. 2 illustrates a bottom-side view of the interlocking moderator member of FIG. 1 according to one embodiment of the present invention;

FIG. 3 illustrates a top-side view of another example of an interlocking moderator member for creating a radiation shielding structure according to one embodiment of the present invention;

FIG. 4 illustrates a side view of a radiation shielding structure comprising interlocking moderator members according to one embodiment of the present invention; and

FIG. 5 illustrates a top view of another radiation shielding structure comprising interlocking moderator members according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The various embodiments of the present invention are advantageous provide many advantages over conventional radiation shielding systems. For example, the various embodiments of the present invention include a modular shielding system that is used to shield against radiation, nuclear and/or fissile materials, and/or systems that generate neutrons, gamma, beta, alpha, and or x-rays. The various embodiments enable enables the build-out of a shielding wall, multi-walled or multi-sided with ceiling or floor structure made out of individual interconnecting shielding modules. Another advantage is that solid shielding material(s) are used that are configured so that each module can interconnect to another module on any of the six sides of the shielding module. Yet another advantage is that at least some embodiments include hollowed shielding modules that can be filled with additional shielding material such as (but not limited to) boronated water. The modular shielding units allow for rapid deployment and scalability of a permanent or temporary shielding structure. The moderator structure can also be dismantled and relocated. The shield can also be designed to moderate neutrons to desired levels.

Modular Radiation Shielding System

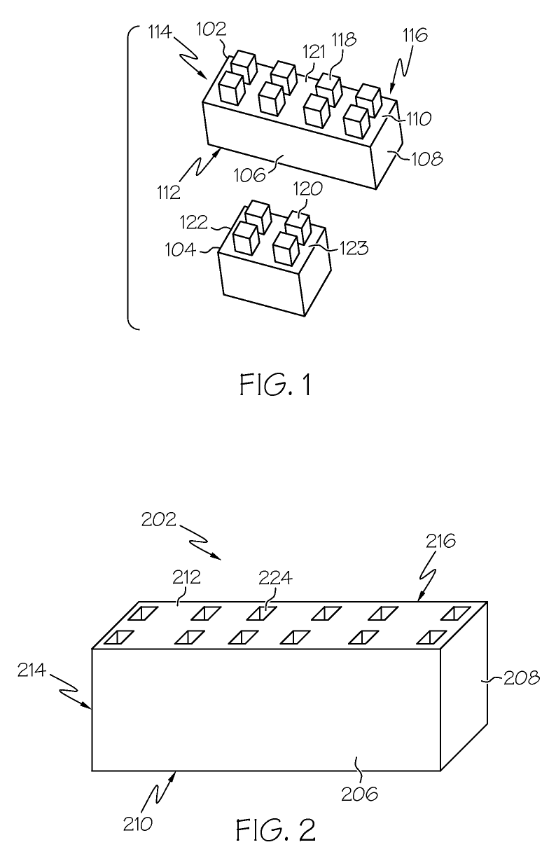

According to one embodiment of the present invention, as shown in FIG. 1, moderator interconnection modules 102, 104 herein referred to as “interlocking shielding units” (ISUs) are illustrated. These ISUs 102, 104 can be connected together to create shielding structures for neutrons, gamma, beta, alpha and or x-rays. The ISUs 102, 104 provide an ability to rapidly create a shielding structure for protection from radiation or fissile materials or systems that generate neutron, gamma, alpha beta, and/or x-rays. The ISUs 102, 104 can also be used to create a moderator system for fast neutrons; a re-locatable shielding or moderator system; and/or a rapid deployment shielding or moderator system.

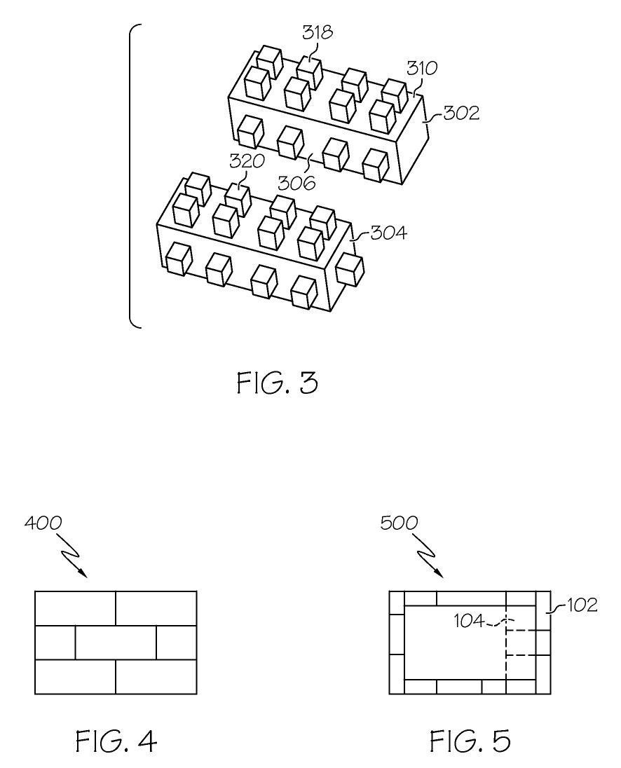

In one embodiment, each ISU 102, 104 comprises a plurality of sides 106, 108, 110, 112, 114, 116. In the example of FIG. 1, the ISUs 102, 104 comprise six sides; however, any geometric configuration that allows the ISUs 102, 104 to be interconnected is also applicable to the various embodiments of the present invention. In one embodiment, an ISU 102, 104 comprises one or more interconnecting members 118, 120 that extend outward from the surface 122 of one or more sides 110 on which the members 118, 120 are disposed (FIG. 1 shows only one side 110 comprising the interconnecting members 118 while FIG. 3 shows interconnecting members 318 on a plurality of sides 306, 310). Each ISU 102, 104, in one embodiment, also comprises recessed members 224 disposed one or more sides 206, 208, 210, 212, 214, 216 of the ISU, as shown in FIG. 2. These recessed areas 224 are configured to receive at least one interconnecting members 118, 120. Once an interconnecting member 118, 120 is inserted into a corresponding recessed area 224 the interconnecting member 118, 120 is secured within the recessed area 224. This allows for two or more ISUs 102, 104 to be coupled together in a secure and stable configuration while still allowing the blocks to be decoupled from one another.

It should be noted that all ISUs 102, 104 are not required to comprise interconnecting members 118, 120 or recessed areas 224. For example, some ISUs 102, 104 can be designated as base blocks or foundation blocks. Therefore, these ISUs generally do not require recessed areas 224 since they are disposed on the bottom of the structure. These ISUs, however, include interconnecting members 118, 120 to be inserted into the recessed areas 224 of the ISUs directly above or adjacent to the ISU. Additionally, the top most ISU, in some instances, do not require interconnecting members 118, 120 (at least on the top surface) since these ISU are disposed at the top most portion of the shielding system. However, these top most ISUs can include interconnecting members 118, 120 on the bottom 112, and side surfaces 108, 114, 116.

It should also be noted that interconnecting members 118, 120 and recessed areas 224 can be disposed on the same side of the ISU. This configuration allows for an even more secure interconnection between ISUs. For example, the interconnecting members 118 of a first ISU 102 are inserted into the recessed areas 224 of a second ISU 104 while the interconnecting members 120 of the second ISU 104 are inserted into the recessed areas 224 of the first ISU 102.

The ISUs 102, 104, in one embodiment, are deployed to create a shield structure 400, 500 of various configurations, as shown in FIGS. 4 and 5. These radiation shields can be used to shield various radiation such as (but not limited to) neutron particles, gamma particles, beta particles, alpha particles, and x-rays. Various nuclear, medical, scientific, etc. applications and devices can be shield from various radiation via the shield structure.

As can be seen from FIG. 5, the shield is not limited to a single wall and can also include ISUs 102, 104 stacked on top of each other and adjacent to each other. The ISUs 102, 104 can be made to any size or shape such as (but not limited to) a rectangle. The ISU 102, 104, in one embodiment, is constructed of a solid shielding material or can be made as a hollow unit that when interconnected creates an internal cavity to allow the addition of a liquid shield such as boronated water to be applied. It should be noted that in another embodiment, one or more sides 106, 108, 110, 112, 114, 116 of two or more ISUs 102, 104 can included a recessed portion that creates a hollow area when the ISUs 102, 104 are interconnected. In other words, a hollow area is created between the two interconnected ISUs 102, 104.

Solid ISUs 102, 104 can be used to form a shield structure for nuclear applications. Each of the solid ISUs are interlocked together to form a solid shield structure. Another embodiment uses hollow ISU units with openings at each of the interconnecting blocks 102, 104. This configuration forms a shield housing for liquid shielding materials such as bromated water to fill the formed cavity. This is especially useful for rapid re-locatable shielding structures. Another embodiment of uses the modular shielding structure as a neutron moderator to moderate the neutrons to a desired level based on the ISU design.

Examples of shielding materials for neutron or fissile protection are typically materials that include low-Z elements such as water, soil, concrete, and polyethylene. Water can be combined with boron to increase effective shielding. One applicable material for the interlocking shielding unit is polyethylene, but other materials are applicable as well. One applicable added material to an ISU with a cavity is boronated water, but other added materials are applicable as well. Boron can be included as a neutron absorber in various materials. For example, borated graphite, a mixture of elemental boron and graphite can be used in fast-reactor shields. Boral, consisting of boron carbide (B₄C) and aluminum, and epoxy resins and resin-impregnated wood laminates incorporating boron can be used for local shielding purposes. Boron can also be added to steel for shield structures to reduce secondary gamma ray production.

Examples of shielding materials for gamma ray protection are as follows. Lead and other high-mass density materials are good shielding materials for gamma radiation. Gamma radiation is the same type of radiation as x-rays (called electromagnetic radiation); it may differ significantly in energy from some x-rays, but the same kinds of materials effective against x-rays are also good for gamma rays.

An important properties of a material for shielding against x-rays and gamma rays is its electron density, and high-mass density. Materials such as lead have high electron densities. Such materials are also effective against some common particulate radiations, such as alpha particles and beta particles, although these particles are much more easily stopped by materials than are x-rays or gamma rays, and much smaller thicknesses of the materials are generally required.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A radiation shielding system comprising:
at a first shielding member;
at least a second shielding member coupled to the first shielding member,
wherein each of the first and second shielding member comprises a moderator material,
wherein at least the first shielding member comprises at least one locking member extending from a surface of a region where the at least one locking member is disposed,
wherein at least the second shielding member comprises at least one recessed area on a side of the second shielding member corresponding to the side of the first shielding member, and
wherein the second shielding member is coupled to the first shielding member by the recessed area receiving the locking member.

2. The radiation shielding system of claim 1, wherein structure formed by the second shielding member being coupled to the first shielding member substantially blocks at least one of
neutrons,
gamma rays,
alpha particles,
beta particles, and
x-rays,
from passing through the structure.

3. The radiation shielding system of claim 1, wherein at least one of the first shielding member and the second shielding member comprises a cavity.

4. The radiation shielding system of claim 3, wherein the at least one locking member comprises an opening that extends down into the cavity.

5. The radiation shielding system of claim 4, wherein when the first shielding member and the second shielding member are coupled together, the opening of the locking member is sealed.

6. The radiation shielding system of claim 3, wherein the cavity is filled with at least one shielding material.

7. The radiation shielding system of claim 6, wherein the at least one shielding materials is boronated water.

8. The radiation shielding system of claim 1, wherein the first shielding member and the second shielding member are temporarily coupled together.

9. The radiation shielding system of claim 1, wherein a structure formed by the first and second shielding members being coupled together form a moderator for at least one of nuclear or fissile materials that moderator neutrons based on a desired interlocking moderator design.

10. An interlocking radiation shield member:
a moderator material; and
at least of:
one or more locking members extending from a surface of a region where the one or more locking members are disposed; and
at least one recessed adapted to receive a locking member of an interlocking radiation shield member.

11. The interlocking radiation shield member of claim 10, wherein the moderator material substantially blocks at least one of:
neutrons,
gamma rays,
alpha particles,
beta particles, and
x-rays,
from passing through the interlocking radiation shield member.

12. The interlocking radiation shield member of claim 10, further comprising a cavity.

13. The interlocking radiation shield member of claim 12, wherein at least one of the one or more locking members comprises an opening that extends down into the cavity.

14. The interlocking radiation shield member of claim 13, wherein when the opening is adapted to be sealed when locking member is inserted into a corresponding recessed area of an interlocking radiation shield member.

15. interlocking radiation shield member of claim 2, wherein the cavity is filled with at least one shielding material.

16. The interlocking radiation shield member of claim 15, wherein the at least one shielding materials is boronated water.
